(19) United States
(12) Patent Application Publication
(10) Pub. No.: US 2018/0022985 A1
(43) Pub. Date: Jan. 25, 2018

(54) METHOD OF USING CATIONIC POLYMERS COMPRISING IMIDAZOLIUM GROUPS FOR PERMANENT CLAY STABILIZATION

(71) Applicants: BASF SE, Ludwigshafen (DE); BASF Corporation, Florham Park, NJ (US)

(72) Inventors: Michael SIEMER, Neuhofen (DE); Jean-Pierre Berkan LINDNER, Mannheim (DE); Shawn RIMASSA, Katy, TX (US); Nikolas KAPRINIDIS, New York, NY (US)

(21) Appl. No.: 15/536,599

(22) PCT Filed: Dec. 7, 2015
(86) PCT No.: PCT/EP2015/078819

§ 371 Date: Jun. 16, 2017

Related U.S. Application Data
(60) Provisional application No. 62/092,848, filed on Dec. 17, 2014.

(51) Int. Cl. C09K 8/60; C09K 8/035; C09K 8/78; C09K 8/588; C09K 8/62; C09K 8/70; C08G 73/06; C09K 8/52

(52) U.S. Cl. CPC C09K 8/608; C08G 73/0616; C09K 8/035; C09K 8/52; C09K 8/588; C09K 8/62; C09K 8/703; C09K 8/78; C09K 2208/12

(57) ABSTRACT

Method of inhibiting the swelling of clay in subterranean formations by introducing carrier fluid comprising at least one clay inhibitor into the formation, wherein at least one of the clay inhibitors is a cationic polymer comprising imidazolium groups having a high weight average

### CROSS-REFERENCE TO RELATED APPLICATIONS

This application is a national stage application (under 35 U.S.C. §371) of PCT/EP2015/078819, filed Dec. 7, 2015, which claims benefit of U.S. Application No. 62/092,848, filed Dec. 17, 2014, both of which are incorporated herein by reference in their entirety.

The present invention relates to a method of inhibiting the swelling of clay in subterranean formations by introducing carrier fluid comprising at least one clay inhibitor into the formation, wherein at least one of the clay inhibitors is a cationic polymer comprising imidazolium groups having a high weight average molecular weight.

Subterranean oil-bearing formations often comprise days. The presence of such clays may give rise to problems when oil is produced from such formations and the days come into contact with aqueous fluids injected into the formation such as stimulation fluids or fluids for enhanced oil recovery and/or connate waters because the clays can swell thereby reducing the permeability of the formation.

It is known in the art to use additives which inhibit or at least minimize swelling or disintegration and migration of clay. For example such additives may be added to the treatment fluid and/or the formation may be pre-flushed with an aqueous fluid which comprises such additive(s).

Suitable additives include inorganic salts, in particular potassium chloride. It is assumed that K⁺ ions exchange against Na⁺ ions present in the clays thus yielding modified clays which are less sensitive to swelling in aqueous fluids.

It is also known in the art to use monomeric or polymeric organic compounds for clay inhibition, such as for example choline chloride or choline formate.

U.S. Pat. No. 8,084,402 B2 discloses a method of inhibiting swelling of clay particulates by injecting a well treatment formulation which comprises imidazolium cations derived from imidazole or substituted imidazole and various anions.

US 2012/0103614 A1 discloses a drilling fluid which comprises imidazolium cations.

U.S. Pat. No. 6,350,721 B1 discloses a fluid for matrix acidizing which comprises imidazolium and/or pyridinium salts.

U.S. Pat. No. 4,158,521 discloses a method for stabilization of an subterranean formation comprising clay particles using a copolymer of epichlorhydrin and dimethylamine.

U.S. Pat. No. 4,447,342 discloses to use cationic polymers for clay stabilization, for example poly(1,5-dimethyl-1,5-diaza-undecamethylene methobromide), poly(dimethylamine-co-epichiorhydrine), Poly(diallyldimethylammonium chloride) or poly(methacrylamido-4,8-diaza-4,4,8,8-tetramethyl-6-hydroxynonamethylene methochloride).

US 2004/0045712 A1 discloses polymers of a dialkyl aminoalkyl methacrylate which can optionally be quaternized with an alkyl halide for clay inhibition.

US 2005/0215439 A1 discloses a composition for clay stabilization comprising poly(dimethylamino(meth)acrylate quaternary salt) having a molecular weight of 1,000 g/mol to 100,000 g/mole.

Although already a number of clay inhibitors are known in the art there is still a need for improvements in particular with respect to permanent clay inhibition. Many inhibitors have only a temporary effect. Once the clay is no longer in contact with the solution comprising the inhibitors the effect of the inhibitors decreases. There is need for improved inhibitors having a permanent effect, i.e. the effect of the inhibitors should be maintained for a long time even if the clays are no longer in contact with a solution comprising inhibitors.

U.S. Pat. No. 6,146,770 B1 discloses cationic polymers comprising imidazolium groups in which the nitrogen atoms of the imidazolium groups are linked together with spacer groups such as polyalkylene groups. The polymers are available by reaction of compounds comprising two imidazole groups with dibromo compounds. It is suggested to use such cationic polymers as protective agent for keratin fibres, e.g. In cosmetic compositions, hair dyeing compositions or bleaching compositions. It has not been suggested to use such polymers for oilfield applications.

US 2011/0263810 A1 discloses cationic polymers comprising imidazolium groups in which the nitrogen atoms of the imidazolium groups are linked together with spacer groups such as polyalkylene groups which are available by reaction of an α-dicarbonyl compound, an aldehyde, at least one amino compound having at least two primary amino groups, and a protic acid. The number average molecular weight Mₙ of the polyimidazolium polymers may be from 500 g/mol to 500,000 g/mol, in particular 500 g/mol to 50,000 g/mol. It is suggested to use such cationic polymers as dispersants. It has not been suggested to use such polymers for oilfield applications.

It was an object of the present invention to provide a method for long-term inhibition of the swelling of clays in subterranean formations.

Correspondingly, a method of inhibiting the swelling of clay in subterranean formations has been found which at least comprises introducing a carrier fluid comprising at least one clay inhibitor into the formation, wherein at least one of the clay inhibitors is a cationic polymer comprising repeating units (I) selected from the group of

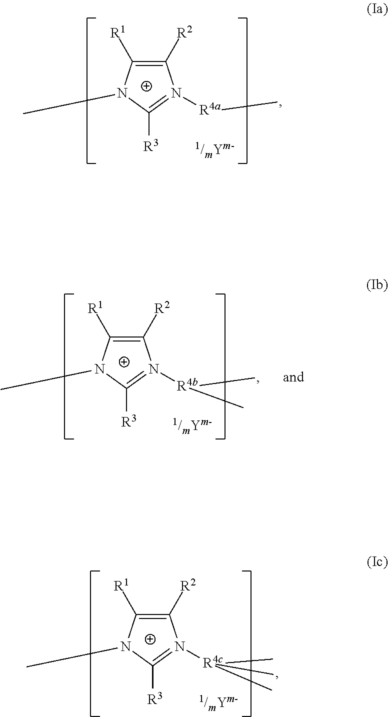

wherein
R¹, R², and R³ are each, independently of one another, H or a saturated or unsaturated, branched or unbranched, aliphatic and/or aromatic hydrocarbon moiety having from 1 to 20 carbon atoms which optionally may be substituted with functional groups,
R^{4a}, R^{4b}, R^{4c} are each, independently from one another, divalent, trivalent or tetravalent organic groups respectively comprising 2 to 50 carbon atoms, wherein the organic groups R^{4a}, R^{4b}, and R^{4c} may optionally comprise functional groups and/or non-neighboring carbon atoms may be substituted by heteroatoms,
Y^{m-} are each, independently of one another, anionic counter ions, wherein m is an integer from 1 to 4,
   and wherein the cationic polymer has a weight average molecular weight M_{w} of at least 70,000 g/mol.

### A BRIEF DESCRIPTION OF THE FIGURES

FIG. 1 shows the pressure difference as a function of the amount of injected fluid (as pore volumes) for a test without clay stabilizer.

FIG. 2 shows the pressure as a function of the amount of injected fluid (as pore volumes) for sample 2 (polymeric imidazolium salt, Mw 236,800 g/mol).

### SPECIFIC DETAILS OF THE INVENTION ARE AS FOLLOWS

### Cationic Polymers to be Used

For the method of Inhibiting the swelling of clay according to the present invention cationic polymers comprising imidazolium groups are used. Such polymers are sometimes also termed as polymeric imidazolium salts.

In the cationic polymers imidazolium cations are linked together via their N-atoms by 2- to 4-valent organic groups R⁴ to form a polymer chain. Cationic polymers comprising only 2-valent linking groups are linear, whereas 3- or 4-valent linking groups yield branched polymers. The polymers may of course comprise only one type of groups R⁴ or different types. The groups R⁴ are selected from the group of divalent organic groups R^{4a}, trivalent organic groups R^{4b} and tetravalent organic groups R^{4c}.

In particular, the cationic polymers to be used according to the invention comprise repeating units (I) selected from the group of

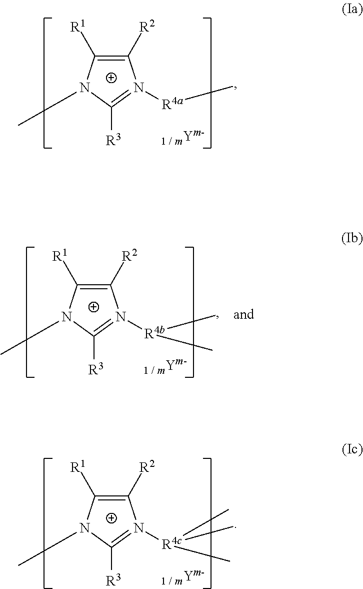

In formulas (Ia), (Ib) and (Ic) R¹, R², and R³ are each, independently of one another, an H atom or a saturated or unsaturated, branched or unbranched, aliphatic and/or aromatic hydrocarbon moiety having from 1 to 20 carbon atoms. The hydrocarbon moieties may be unsubstituted or may comprise additional functional groups. In one embodiment of the invention, R¹ and R² are hydrogen or saturated, aliphatic hydrocarbon moieties having from 1 to 20, preferably 1 to 6 carbon atoms. In a preferred embodiment, both R¹ and R² are H.

The groups R^{4a}, R^{4b}, and R^{4c} are organic groups each. R^{4a} is a divalent organic group, R^{4b} is a trivalent organic group and R^{4c} is a tetravalent organic group. The term “organic groups” means in principally known manner that the group at least comprises carbon atoms and hydrogen atoms. Preferably, the organic groups R^{4a}, R^{4b}, and R^{4c} comprise, independently of one another, 2 to 50 carbon atoms, in particular 4 to 50, more preferably 4 to 40 and particularly 4 to 20 carbon atoms. The groups may be aliphatic and/or aromatic groups, preferably aliphatic groups.

Besides carbon and hydrogen the organic groups R^{4a}, R^{4b}, and R^{4c} may comprise functional groups and/or non-neighboring carbon atoms may be substituted by heteroatoms, in particular O- and/or N atoms. Examples of functional groups comprise hydroxyl groups, ether groups, ester groups, amide groups, aromatic heterocycles, keto groups, aldehyde groups, primary or secondary amino groups, imino groups, thioether groups, halide groups or acid groups such as carboxylic acid groups, phosphonic acid groups or phosphoric acid groups

In one embodiment, the organic linking groups R^{4a}, R^{4b}, and R^{4c} may comprise ether groups or secondary or tertiary amino groups and apart from these no further functional groups.

In one preferred embodiment, R^{4a}, R^{4b}, and R^{4c} are pure hydrocarbon moieties and do not comprise any functional groups. The hydrocarbon moieties may be aliphatic or aromatic or may comprise both aromatic and aliphatic groups. Preferably, R^{4a}, R^{4b}, and R^{4c} are aliphatic moieties.

Bivalent linking groups R^{4a} preferably are aliphatic hydrocarbon moieties, preferably linear aliphatic hydrocarbon moieties comprising 2 to 50 carbon atoms, preferably 3 to 40 and particularly 4 to 20 carbon atoms which may optionally be further substituted. If the groups are substituted they preferably comprise at most ether groups, secondary or tertiary amino groups, or carboxylic acid groups and apart from these no further functional groups. Preferably, the groups R^{4a} are unsubstituted.

Examples of preferred bivalent linking groups R comprise C₂-C₂₀ alkylene groups, in particular 1,ω-C₂-C₂₀ alkylene groups, preferably C₄-C₁₂ alkylene groups, in particular 1,ω-C₄-C₁₂ alkylene groups such as 1,4-butylene or 1,6-hexylene groups.

Further examples of preferred linking groups R^{4a} comprise groups of the general formula —(CH₂)_{y}—X—(CH₂)_{y}— (II), wherein X is a group selected form arylene groups, such as a 1,4-phenylene group, cycloalkylene groups, such as a 1,4-cyclohexylene group or O-atoms.

An example of a substituted bivalent linking group R^{4a} comprises a polyether group —(—CH₂—CH₂O—)_{z}—CH₂CH₂—, wherein z is from 1 to 49, preferably from 2 to 40.

Trivalent linking groups R^{4b} preferably are aliphatic hydrocarbon moieties, comprising 3 to 40 and particularly 4 to 20 carbon atoms which may optionally be further substituted. If the groups are substituted they preferably comprise at most ether groups, secondary or tertiary amino groups, or carboxylic acid groups and apart from these no further functional groups. It is self-evident that R^{4b} comprises at least one branching atom. Such branching atom may be a carbon atom but it may also be a N-atom.

Examples of preferred trivalent linking groups R^{4b} comprise groups of the formula (II)

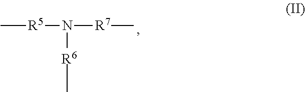

wherein R⁵, R⁶ and R⁷ are each, independently of one another, C₁-C₁₀ alkylene groups, preferably a C₂-C₆-alkylene groups. In one embodiment R⁵, R⁶ and R⁷ have the same meaning and may be an ethylene group —CH₂CH₂— each.

Further examples of trivalent linking groups R^{4b} comprise

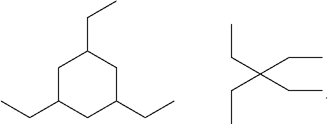

Tetravalent linking groups R^{4c} preferably are aliphatic hydrocarbon moieties comprising 4 to 40 and particularly 4 to 20 carbon atoms which may optionally be further substituted. If the groups are substituted they preferably comprise at most ether groups, secondary or tertiary amino groups, or carboxylic acid groups and apart from these no further functional groups. It is self-evident that R^{4c} comprises at least one branching atom. Such branching atom may be a carbon atom but it may also be a N-atom.

Examples of preferred tetravalent linking groups R^{4c} comprise the

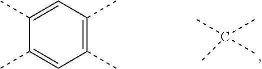

The cationic polymers comprising imidazolium groups may optionally comprise besides the groups (Ia), (Ib), or (Ic) other repeating units. Introducing other repeating units may be performed by the skilled artisan in order to fine tune the properties of the cationic polymer. In general, the amount of repeating units (I), selected from (Ia), (Ib), and (Ic) is at least 80 mol %, relating to the total amount of all repeating units, preferably at least 90 mol % and particularly only repeating units selected from (Ia), (Ib), and (Ic) should be present. It goes without saying for the skilled artisan that the polymer also comprises terminal groups which have a structure different form that of the repeating units.

The cationic polymers comprising imidazolium groups may comprise only one type of repeating groups (Ia), (Ib) or (Ic) or two of them or all of them. In one embodiment of the invention the cationic polymers comprise at least repeating groups (Ib), preferably, the amount of groups (Ia) should be at least 50 mol %, preferably at least 80 mol %, more preferably at least 90 mol %, most preferably at least 95 mol %, relating to the total amount of an repeating units and in a particularly preferred embodiment, the cationic polymer comprises only repeating units (Ia).

The cationic polymers comprising imidazolium groups furthermore comprise negatively charged counter ions. Such counter ions may be separate ions Y^{m-}, wherein m is a positive integer. In a preferred embodiment, m is an integer from 1 to 4, particularly preferably 1 or 2. In a particular embodiment, m is 1. The number of counter ions is 1/m per imidazolium group. If the linking groups R⁴ comprises anionic groups or groups which can be converted into anionic groups, e.g. carboxylic acid groups a separate counter ion may not be necessary. In such a case the polymer comprising imidazolium groups is amphoteric, i.e. it comprises positive and negative charges in the same molecule.

In one preferred embodiment of the invention the anionic counter ions are derived from mono- or polycarboxylic acids, i.e. they comprise at least one —COO⁻ group. In particular, suitable anionic counter ions are derived from aliphatic and/or aromatic carboxylic acids, in particular mono- or dicarboxylic acids comprising 1 to 20, preferably 1 to 12 carbon atoms. Examples of counter ions comprise the anions of formic acid, acetic acid, phthalic acid, of isophthalic acid, of C₂- to C₆-dicarboxylic acids such as oxalic acid, malonic acid, succinic acid, glutaric acid or adipic acid. Examples of preferred counter ion comprise formiate and acetate, in particular acetate.

Further examples of suitable counter ions are disclosed in detail in US 2011/0263810 A1 paragraphs [0052] to [0074].

Surprisingly, it has been found that the molecular weight of the water-soluble cationic polymers to be used in the method according to the present invention has a pronounced effect on the performance of the polymers for the inhibition of the swelling of clay in subterranean formations. The higher the molecular weight of the water-soluble cationic polymers the better the permanency of the inhibition of the swelling of clay.

Accordingly, the cationic polymers to be used in present invention should have a weight average molecular weight M_{w} of at least 10,000 g/mol, in particular 10,000 g/mol to 1,000,000 g/mol, preferably 20,000 g/mol to 600,000 g/mol.

In one preferred embodiment of the invention, the cationic polymers to be used in present invention should have a weight average molecular weight M_{w} of at least 70,000 g/mol, in particular 70,000 g/mol to 1,000,000 g/mol, preferably 80,000 g/mol to 600,000 g/mol, more preferably 100,000 g/mol to 500,000 g/mol, most preferably 150,000 g/mol to 350,000 g/mol and for example 200,000 g/mol to 300,000 g/mol.

### Synthesis of the Cationic Polymers

The cationic polymers comprising imidazolium groups described above may be synthesized by any method. Suitable methods are known to the skilled artisan.

### Method (I)

In one embodiment the polymers may be synthesized by the process disclosed in U.S. Pat. No. 6,146,770 B1. The method is a two-step process: In the first step an alkylene bridged bisimidazole Im-(CH₂)ₙ-Im (Im=imidazole) is synthesized which in the second step is reacted with an alkylene dibromide such as 1,3-dibromopropane thus yielding a polymeric imidazolium compound.

### Method (II)

### Starting Materials for Method (II)

In a preferred embodiment of the invention, the polymeric imidazolium salts are available by a process wherein at least an α-dicarbonyl compound, an aldehyde, at least one amino compound having 2 to 4 primary amino groups, and a protic acid are reacted with one another. Such a process has been described for instance in US 2011/0263810 A1.

The reaction is a polycondensation. In a polycondensation, polymerization occurs with elimination of a low molecular weight compound such as water or alcohol.

In the present case, water is eliminated in case of carbonyl groups. To the extent the carbonyl groups have the form of a ketal or hemiketal, acetal or hemiacetal group, an alcohol is eliminated instead of water.

The α-dicarbonyl compound is preferably a compound of the formula R¹—CO—CO—R² (III) wherein R¹ and R² have the meaning a defined above. The compound (III) is particularly preferably glyoxal, i.e. both R¹ and R² are hydrogen.

The carbonyl groups of the α-dicarbonyl compound may also be present as ketal or hemiketal, preferably as hemiketal or ketal of a lower alcohol, e.g. a C₁- to C₁₀-alkanol. In this case, the alcohol is eliminated in the later condensation reaction. The carbonyl groups of the α-dicarbonyl compound are preferably not present as hemiketal or ketal.

The aldehyde is in particular an aldehyde of the formula R³—CHO (IV), wherein R³ has the meaning as defined above. Particular preference is given to formaldehyde, i.e. R³=H; the formaldehyde can also be used in the form of compounds which liberate formaldehyde, e.g. paraformaldehyde or trioxane.

The aldehyde group of the aldehyde may also be present as hemiacetal or acetal, preferably as hemiacetal or acetal of a lower alcohol, e.g. a C₁- to C₁₀-alkanol. In this case, the alcohol is eliminated in the later condensation reaction. The aldehyde group is preferably not present as hemiacetal or acetal.

The amino compound is a compound having 2 to 4 primary amino groups. It can be represented by the general formula R⁴(—NH₂)ₙ (V), wherein n is 2, 3, or 4 and R⁴ is a 2- to 4-valent organic moiety which has the meaning as defined above. As also mentioned above, R⁴ may be selected from the group of R^{4a}, R^{4b}, and R^{4c}, i.e. the amino compounds may be selected from diamines H₂N—R^{4a}—NH₂, triamines R^{4b}(—NH₂)₃, and tetramines R^{4c}(—NH₂)₄.

Diamines H₂N—R^{4a}—NH₂ which may be mentioned are, in particular, C₂ to C₂₀-alkylenediamines, preferably C₄- to C₁₂ diamines such as 1,4-butylenediamine or 1,6-hexylenediamine.

Examples of possible triamines R^{4b}(—NH₂)₃ comprise aliphatic compounds of the formula (VI)

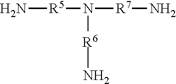

wherein R⁵, R⁶ and R⁷ each, independently of one another have the meaning as defined above. An example which may be mentioned is triaminoethylamine (R⁵=R⁶=R⁷=ethylene).

Further examples of possible triamines R^{4b}(—NH₂)₃ comprise amines of the following formulas:

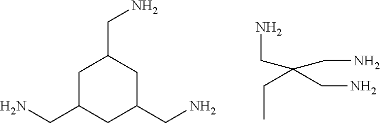

Examples of possible tetramines R(—NH₂)₄ comprise

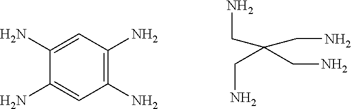 [SMILES: Nc1cc(N)c(N)cc1N ; NCC(CN)(CN)CN]

When diamines are used in the present manufacturing method, linear cationic polymers are formed, while in the case of amines having more than two primary amino groups, branched polymers are formed. Particular preference is given to n=2 (diamines) or n=3 (triamines). Very particular preference is given to n=2.

It is also possible to use, in particular, mixtures of amino compounds in the process of the invention. In this way, polymers comprising imidazolium groups which comprise different groups R⁴ between the imidazole rings are obtained. The use of such mixtures makes it possible to set desired properties such as glass transition temperature, elasticity, hardness or solubility in water in a targeted way.

It is of course possible to use further compounds, e.g. In order to introduce specific end groups or additional functional groups into the polymer to set defined properties. For instance, it may be possible to use compounds having only one primary amino group in order to influence the molecular weight of the polymeric imidazolium compounds or it may be possible to use compounds having more than 4 amino groups, however it is preferred to use no other amines than those of the general formula (V).

The protic acid which is used in method (II) may be represented by the formula Y^{m-}(H⁺)ₘ, where Y^{m-} has the meaning as defined above. The anion Y^{m-} of the protic acid forms the counter ion to the imidazolium groups of the cationic polymer.

The anion of a protic acid is preferably the anion of a protic acid having a pKₐ of at least 1, in particular at least 2 and in a very particularly preferred embodiment at least 4. The pKₐ is the negative logarithm to the base 10 of the acid constant, Kₐ. The pKₐ is for this purpose measured at 25° C., 1 bar, either in water or dimethyl sulfoxide as solvent; it is therefore sufficient, according to the invention, for an anion to have the corresponding pKₐ either in water or in dimethyl sulfoxide. Dimethyl sulfoxide is used particularly when the anion is not readily soluble in water. Information on the two solvents may be found in standard reference works.

Suitable anions/acids have already been disclosed above. Preferred protic acids are carboxylic acids, sulfonic acids, phosphoric acids or phosphonic acids. Further examples of suitable acids are disclosed in detail in US 2011/0263810 A1 paragraphs [0052] to [0074].

In one preferred embodiment of the preferred method for making the polymers the acids are mono- or polycarboxylic acids. In particular suitable acids comprise aliphatic and/or aromatic carboxylic acids, in particular mono- or dicarboxylic acids comprising 1 to 20, preferably 1 to 12 carbon atoms, such as formic acid, acetic acid, phthalic acid, isophthalic acid, C₂- to C₆-dicarboxylic acids such as oxalic acid, malonic acid, succinic acid, glutaric acid or adipic acid. Most preferred are formic acid and acetic acid, in particular acetic acid.

### Process According to Method (II)

The reaction proceeds in principle according to the following reaction equation.

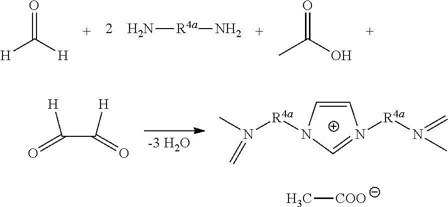

Here, 1 mol of aldehyde, 1 mol of a diamine, 1 mol of the protic acid and 1 mol of the α-dicarbonyl compound are used. In the polymer obtained, the imidazolium groups are joined to one another by the diamine.

High molecular weights in polycondensations should be achieved when the compounds are used in equimolar amounts.

Surprisingly, it has been found however, that the formation of polymers comprising imidazolium groups having high molecular weight is improved with a molar ratio of the α-dicarbonyl compound to the oligoamine of greater than; hence a molar excess of the α-dicarbonyl compound is used.

In a preferred embodiment the molar ratio the of α-dicarbonyl compound to the oligoamine is from 1.001:1 to 2:1, more preferred is a ratio of 1.01:1 to 1.01:1.5; particularly preferred is a ratio of the of α-dicarbonyl compound to the oligoamine of 1.01:1 to 1.01:1.2.

It is preferred that the aldehyde is used in molar excess as well, the molar ratio of the aide-hyde to the oligoamine being greater than 1 as well.

In a preferred embodiment the molar ratio the of the aldehyde to the oligoamine is from 1.001:1 to 2:1, more preferred is a ratio of 1.01:1 to 1.01:1.5; particularly preferred is a ratio of the aldehyde to the oligoamine of 1.01:1 to 1.01:1.2.

By using an excess of the α-dicarbonyl compound and optionally also an excess of the aldehyde, cationic polymers comprising imidazolium groups and having a weight average molecular weight M_{w} of at least 70,000 g/mol can be easily obtained.

The reaction of the starting compounds is preferably carried out in water, a water-miscible solvent or mixtures thereof.

Water-miscible solvents are, in particular, protic solvents, preferably aliphatic alcohols or ethers having not more than 4 carbon atoms, e.g. methanol, ethanol, methyl ethyl ether, tetrahydrofuran. Suitable protic solvents are miscible with water in any ratio (at 1 bar, 21° C.).

The reaction is preferably carried out in water or mixtures of water with the above protic solvents. The reaction is particularly preferably carried out in water.

During the reaction the pH value is preferably 1 to 7, most preferably 3 to 5. The pH value may be kept or adjusted by any suitable manner, for example by adding acids or suitable puffer systems. In a preferred embodiment an excess of the protic acid which is used as starting material may be used to adjust the pH value.

In a preferred embodiment the molar ratio of the protic acid to the oligoamine may be from 1.05:1 to 10:1, in particular from 1.2 to 5, respectively 1.5 to 5.

The starting components can be combined in any order.

The reaction of the starting components can be carried out at, for example, pressures of from 0.1 to 10 bar, in particular atmospheric pressure.

The reaction temperature may be below 100° C., for example from 0° C. to 100° C., in particular from 20° C. to 100° C. The reaction is exothermic and cooling may be required. In one embodiment the reaction may be started at temperatures below 100° C., in particular below 50° C., particularly preferably below 40° C., respectively 30° C. In order to avoid freezing the starting temperature should preferably be not lower than 0° C., in particular not be lower than 3° C. (at normal pressure). After starting the reaction the temperature increases due to the exothermic reaction. The temperature should raise to temperatures of at least 80° C., for examples 80° C. to 100° C., preferably at least 90° C., preferably 90° C. to 100° C. If the heat generated by the exothermic reaction is not enough to achieve the temperatures it may be necessary to heat reaction mixture.

The reaction can be carried out batchwise, semicontinuously or continuously. In the semicontinuous mode of operation, it is possible, for example, for at least one starting compound to be initially charged and the other starting components to be metered in.

In the continuous mode of operation, the starting components are combined continuously and the product mixture is discharged continuously. The starting components can be fed in either individually or as a mixture of all or part of the starting components. In a particular embodiment, the amine and the acid are mixed beforehand and fed in as one stream, while the other components can be fed in either individually or likewise as a mixture (2nd stream).

In a further particular embodiment of a continuous process all starting components comprising carbonyl groups (i.e. the α-dicarbonyl compound, the aldehyde and the protic acid of the anion X (if the latter is a carboxylate) are mixed beforehand and fed in together as a stream; the remaining amino compound is then fed in separately.

The continuous preparation can be carried out in any reaction vessels, i.e. in a stirred vessel. It is preferably carried out in a cascade of stirred vessels, e.g. from 2 to 4 stirred vessels, or in a tube reactor.

In a preferred embodiment of a batchwise process the protic acid is placed in the reactor first and the oligoamine, aldehyde and α-dicarbonyl compound are fed to the protic acid in a rate that the temperature of the reaction mixture is kept below 40° C., respectively 30° C. With such procedure the formation of any precipitates during the reaction is essentially avoided.

After the polycondensation reaction has been carried out, the polymeric compounds obtained can precipitate from the solution or remain in solution. Preferably solutions of the polymeric ionic imidazolium compounds are obtained.

The polymeric compounds can also be separated off from the solutions by customary methods. In the simplest case, the solvent, e.g. water, can be removed by distillation or by spray drying.

### Cationic Polymers Available by Method (II)

In one embodiment of the invention for the method of inhibiting the swelling of clay water-soluble cationic polymers comprising imidazolium groups are used which are available by reacting at least an α-dicarbonyl compound, an aldehyde, at least one amino compound having 2 to 4 primary amino groups, and a protic acid with one another.

Preferably, the molar ratio of the α-dicarbonyl compound to the oligoamine is greater than 1.

For further details of the reaction including preferred embodiments we refer to the above mentioned

### Preferred Cationic Polymers

In a preferred embodiment cationic polymer to be used according to the Invention comprises at least 50 mol % of repeating units (Ia) with respect to all repeating units, preferably at least 80 mol %, more preferably at least 95 mol % and most preferably the polymer comprises only repeating units (Ia).

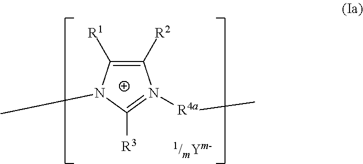

In the preferred embodiment R¹, R² and R³ preferably are H. Furthermore, the groups R^{4a} are independently from each other C₂ to C₂₀ alkylene groups, preferably C₄ to C₁₂ alkylene groups, more preferably C₄ to C₈ alkylene groups. Examples of such groups comprise 1,4-butylene, 1,5-pentylene, 1,6-hexylene, 1,7-heptylene and 1,8-octylene groups. Most preferably R^{4a} is 1,6-hexylene. The anions Y^{m-} preferably are anions of carboxylic acids, in particular formate or acetate and most preferred acetate.

Such a polymer may be derived from formaldehyde, glyoxal and 1,6-hexanediamine in the presence of acetic acid according to method (II) and may be represented by the following formula.

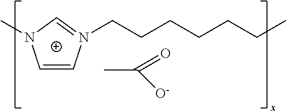

The preferred polymers to be used according to the present invention as described above have a weight average molecular weight M_{w} of at least 70,000 g/mol, in particular 70,000 g/mol to 1,000,000 g/mol, preferably 80,000 g/mol to 600,000 g/mol, more preferably 100,000 g/mol to 500,000 g/mol, most preferably 150,000 g/mol to 350,000 g/mol and for example 200,000 g/mol to 300,000 g/mol.

### Method of Inhibiting the Swelling of Clay

For the method of inhibiting the swelling of clay in subterranean formations according to the present invention a carrier fluid comprising at least one cationic polymer comprising imidazolium groups having a weight average molecular weight M_{w} of at least 70,000 g/mol as described above is provided and the carrier fluid is introduced into the subterranean formation.

The cationic polymers comprising imidazolium groups reduce, prevent or eliminate completely formation damage to the subterranean formation due to clay swelling and/or migration and/or disintegration of the clay due to exposure of connate waters or introduced treatment fluids.

The method of inhibiting the swelling of clay in subterranean formations according to the present invention yields a permanent inhibition. The term “permanent” means that the inhibiting effect not only occurs as long as the clay is in contact with the carrier fluid comprising the inhibiting polymer but at least some inhibiting effect remains at least for some time after the clay is no longer in contact with the carrier fluid comprising the inhibiting polymer but with aqueous fluids which don't comprise an inhibitor such as formation water and/or other injected fluids.

In one preferred embodiment, the carrier fluid may be an aqueous fluid. An aqueous fluid may comprise also organic solvents miscible with water may. Usually, the amount of water is at least 50% by weight relating to the total amount of all solvents used, preferably at least 70% by weight, more preferably at least 90% by weight. In one embodiment of the invention only water is used. The water used may be fresh water but also water comprising salts such as brine, sea water or formation water may be used.

The concentration of the cationic polymers comprising imidazolium groups used in the method according to the present invention may be selected by the skilled artisan according to his/her needs. Usually, the concentration of the polymeric imidazolium salts used according to the present invention is from 0.001% to 1% by weight relating to the amount of all components of the formulation, preferably from 0.005% to 0.5% by weight and most preferably 0.01% to 0.1% by weight.

Of course, also a mixture of different cationic polymers comprising imidazolium groups may be used. Furthermore, the cationic polymers comprising imidazolium groups may be combined with chemically different clay inhibitors.

Besides the cationic polymers comprising imidazolium groups the carrier fluid may of course comprise further components. The kind and amount of further components depends on the specific use of the fluid.

Examples of suitable carrier fluids comprise drilling fluids, completion fluids, stimulation fluids such as fracturing fluids, including but not limited to acidic fracturing fluids, alkaline fracturing fluids and foamed fracturing fluids, matrix acidizing fluids, production/remediation fluids, fluids for enhanced oil recovery (EOR), gravel packs, frac and pack fluids, and welbore clean up fluids. Further components for such fluids are known to the skilled artisan.

In another embodiment of the invention, the carrier fluid comprising at least one cationic polymer comprising imidazolium salts may be used for pre-flushing the formation, i.e. the formation is treated with an aqueous fluid comprising the clay inhibitor first followed by treatment with the desired treatment fluid, such as the fluids mentioned previously. Due to the permanent clay stabilization effect caused by the cationic polymers comprising imidazolium groups which are used in to the present invention, such treatment fluids need not to contain clay stabilizers although this of course is possible.

Any kind of clay may be treated with the cationic polymers comprising imidazolium groups used according to the present invention. Examples of clays include montmorillonite, saponite, nontronite, hectorite, and sauconite, kaolinite, nacrite, dickite, halloysite, hydroblotite, glauconite, illite, bramallite, chlorite or chamosite. Besides clays the formation may of course comprise other minerals.

Surprisingly, it has been found that the cationic polymers comprising imidazolium groups lower the freezing point of aqueous formulations which is an additional benefit if aqueous formulations are used at low temperatures, e.g. In artic regions.

In a preferred embodiment of the invention the cationic polymers comprising imidazolium salts may be used for stimulation applications, including but not limited to fracturing and acidizing.

For hydraulic fracturing a fluid comprising at least a carrier fluid, preferably an aqueous carrier fluid, a thickener, a proppant and at least one cationic polymer comprising imidazolium groups as described above is used which is injected into the formation at a pressure sufficient to fracture the formation. The thickener may comprise thickening polymers such as guar or cellulose type polymers or thickening surfactants, e.g. viscoelastic surfactants.

For acidizing a fluid comprising at least a carrier fluid, preferably an aqueous carrier fluid, an acid and at least one cationic polymer comprising imidazolium groups as described above is used which is injected into the formation. Examples of suitable acids comprise HF and/or HCl and methane sulfonic acid. In matrix acidizing operations the carrier fluid is injected at a pressure not sufficient to fracture the formation, i.e. the permeability of the formation is only increase by impact of the acid whereas in fracture acidizing operations the carrier fluid is injected at a pressure sufficient to fracture the formation.

The following examples are intended to illustrate the invention in detail:

### Tested Samples:

For the tests the following polyimidazolium salts were synthesized:

### Sample 1 (Comparative):

Polyimidazolium acetate based on 1,6-hexamethylenediamine, M_{w} 69,000 g/mol

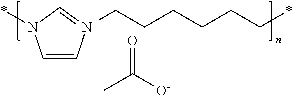

Sample 1 was synthesized according to the following procedure:

2 mol acetic acid are placed in a flask. A mixture of 1.00 mol formaldehyde (49% aq. Solution) and 1.00 mol glyoxal (40% aq. Solution) are added via a dropping funnel to the solution. In parallel, 1 mol of diamine is added to the solution via a separated dropping funnel. During addition of the monomers the reaction mixture is held at room temperature by ice bath cooling. After completion of the addition the reaction mixture is heated to 100° C. for 1-3 hours. An aqueous solution of the polymeric, ionic imidazolium compound is obtained. No precipitates have been observed during or after the reaction.

The molecular weight of the obtained polymer is determined by size exclusion chromatography at 35° C. using SUPREMA® columns (Polymer Standards Service GmbH, Mainz, Germany). The material of the SUPREMA® columns is a poly hydroxymethacrylate copolymer network. The calibration of the columns was performed using Pullulan standards of Polymer Standards Service GmbH, Mainz, Germany. As eluent as solution of 0.02 mol/l of formic acid and 0.2 mol/l of KCl in water was used.

The weight average molecular weight (Mw), the number average molecular weight (Mn) and the polydispersity PDI (Mw/Mn) of sample 1 are:

Mₙ: 23,100 g/mol, M_{w}: 69,000 g/mol, M_{w}/Mₙ=3

### Sample 2:

Polyimidazolium acetate based on 1,6-hexamethylenediamine, M_{w}>200,000 g/mol

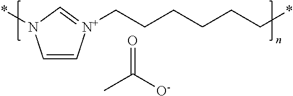

Sample 2 was synthesized according to the following procedure:

The procedure of example 1 has been repeated, however using 1.05 mol formaldehyde and 1.05 mol glyoxal.

M_{w}: 236,800 g/mol, Mₙ 44,760 g/mol), M_{w}/Mₙ=5.3

### Sample 3 (Comparative):

Polyimidazolium salt based on lysine (H₂N—(CH₂)₄—CH(—NH₂)(—COOH)), M_{w} 6180 g/mol

Sample 3 was synthesized according to the following procedure:

The procedure of example 1 has been repeated, however using 1.0 mol formaldehyde and 1.0 mol glyoxal and lysine instead of 1,6-hexamethylenediamine.

Mₙ: 3,570 g/mol, M_{w}: 6,180 g/mol, M_{w}/Mₙ=1.7

### Sample 4 (Comparative):

Polyimidazolium salt based on lysine, M_{w} 6330 g/mol

Sample 4 was synthesized according to the following procedure:

The procedure of example 1 has been repeated, however using 1.0 mol formaldehyde and 1.0 mol glyoxal and lysine instead of 1,6-hexamethylenediamine.

Mₙ: 3,450 g/mol, M_{w}: 6,330 g/mol, M_{w}/Mₙ=1.8

The following table 1 summarizes all samples for the tests:

TABLE 1
Samples used in the tests

| | |
|---|---|
| Sample 1 | Polymeric imidazolium acetate based on |
| (comparative) | 1,6-hexamethylenediamine, M_{w} 69,000 g/mol |
| Sample 2 | Polymeric imidazolium acetate based on |
| | 1,6-hexamethylenediamine, M_{w} 236,800 g/mol |
| Sample 3 | Polyimidazolium salt based on lysine |
| (comparative) | (H₂N—(CH₂)₄—CH(—NH₂)(—COOH)), |
| | M_{w} 6,180 g/mol |
| Sample 4 | Polyimidazolium salt based on lysine, M_{w} 6330 g/mol |
| (comparative) | |
| Sample 5 | Monomeric imidazolium salt: 3-Ethyl-1-ethyl |
| (comparative) | imidazolium acetate |
| Sample 6 | Choline chloride (H₃C)₃N⁺—CH₂CH₂OH Cl⁻ |
| (comparative) | |
| Sample 7 | Choline formate (H₃C)₃N⁺—CH₂CH₂OH HCOO⁻ |
| (comparative) | |
| Sample 8 | Commercially available cationic polymer of |
| (comparative) | epichlorhydrine and amines (epi-amine), |
| | M_{w} 150,000, Mₙ 40,000, solution in water, ~50% |
| | by wt. of actives |

### Test Methods:

### Capillary Suction Test (CST)

### Principle and Apparatus:

The CST studies the filtration characteristics of aqueous systems utilizing the capillary suction pressure of a porous paper to affect filtration. When a suspension is filtered under the influence of this suction pressure, the rate at which filtrate spreads away from the suspension is controlled predominately by the filterability of the suspension. The Capillary Suction Timer automatically measures the time for the filtrate to advance between radially separated electrodes when a fixed area of special filter paper is exposed to the suspension.

The Capillary Suction Timer consists of two separate components: The filtration unit with the electrodes and a timer. A sample of the aqueous system to be tested is placed in the sample cylinder and the suction pressure of the filter paper beneath the sample draws out the filtrate. The filtrate progresses radially in an essentially elliptical pattern with the timer starting when the liquid reaches the first pair of electrodes. When the liquid reaches the third electrode the timing ceases and is indicated on a counter.

### Test Procedure:

### Apparatus and Reagents

OFITE Capillary Suction Timer #294-50

Core material—30 mesh size or smaller

Standard capillary suction timer paper, Whatman #1, Chromatography Grade

3-mL pipette, 10-mL vials

### Procedure

For testing the samples Berea sandstone core which comprises a small amount of clay was ground and sieved to 30 mesh size (≅0.6 mm) or smaller. In a 10 ml vial 0.3 g of sieved core material and 3 ml of water containing the sample to be tested were mixed. 3 ml of the mixture were pipetted into the Capillary Suction Timer and the CST measured as indicated above.

For comparative purposes one test run was made only with water, i.e. without core. One comparative test was performed without adding a clay stabilizer. Samples 1 to 5 were tested at the concentrations indicated in table 2. The results are summarized in table 2.

TABLE 2
Results of CST (*Normalized time = measured time/test run only with water)

| | | Concentration of | | |
|---|---|---|---|---|
| | | clay stabilizer | | Normalized |
| Test No. | Sample No. | [% by weight] | time [s] | Time* |
| Comparative | only water | — | 7.2 | 1 |
| example C1 | | | | |
| Comparative | Only clay containing core without | — | 411.6 | 57 |
| example C2 | stabilizer | | | |
| Comparative | Sample 5, | 0.4 | 12.6 | 1.8 |
| example C3 | monomeric imidazolium salt | | | |
| Comparative | Sample 3, | 0.14 | 57.4 | 8 |
| example C4 | polymeric imidazolium salt, | | | |
| | M_{w} 6,180 g/mol | | | |
| Comparative | Sample 4, | 0.14 | 46.9 | 6.5 |
| example C5 | polymeric imidazolium salt, | | | |
| | M_{w} 6330 g/mol | | | |
| Comparative | Sample 1, | 0.14 | 20.6 | 2.9 |
| example C6 | polymeric imidazolium salt, | | | |
| | M_{w} 69,000 g/mol | | | |
| Example 1 | Sample 2, | 0.024 | 7.9 | 1.1 |
| | polymeric imidazolium salt, | | | |
| | M_{w} 236,800 g/mol | | | |

The CST method is used as a qualitative measure to see if the test fluid may potentially cause formation damage during treatment. A normalized time below 2, it is generally said that the fluid is good—minimum rock/fluid interaction. At units greater than 2, the risk of potential formation damage and greater sensitivity will increase.

The CST for pure water (comparative example C1) is 7.2 s. Mixing the core material with water without any clay stabilizer yields a CST of 411.6 s; i.e. there is a very significant swelling of the clay in the core material which results in very bad filtration characteristics. Adding monomeric and polymeric imidazolium salts significantly improves the filterability of the material. The test with monomeric imidazolium salts resulted in a CST of 12.6 s, yielding a normalized time of less than 2. However, the concentration was 0.4% by weight, i.e. a relatively high concentration. Example 1 using a polymeric imidazolium salt with a weight average molecular weight of M_{w} 236,800 g/mol and used at a concentration of only 0.024% by weight had a CST of only 7.9 s and a normalized time of 1.1, i.e. it performance is nearly the same performance as that of pure water.

### Core Flooding Test

Core flooding tests were performed in order to study the properties of the tests samples with respect to their ability of long term/permanent clay stabilization.

Berea sandstone cores (length 5.12 cm, diameter 2.56 cm) having a permeability of 20 mD (Milli-Darcies≅1.97*10⁻¹⁴ m²) were used for this test. Berea sandstone cores comprise a small amount of clay which will swell in water.

The tests were performed at a temperature of 82.2° C. The core was covered in the usual manner in a Hastelloy cell comprising an inlet and an outlet for liquids in order to allow liquids to be pressed through the core.

The testing procedure comprised 3 steps:

### Step 1: Determination of the Initial Permeability Using KCl

As a first step an aqueous solution comprising 3% by weight of KCl (i.e. a widely distributed non-permanent clay stabilizer) were injected at a rate of 5 ml/min until a constant pressure was achieved and the initial permeability of the core was in the usual manner.

Step 2: Flooding with Clay Inhibitors

After the first step 5 pore volumes (PV) of an aqueous solution comprising 3% by weight of KCl and the clay inhibitor to be tested were injected into core. The respective concentrations of the tested clay inhibitors are listed in table 3. The injection rate was reduced to zero and the clay inhibitor was allowed to place (system shut in) for two hours. After the two hour shut-in another 5 PV of an aqueous solution comprising 3% by weight of KCl without day inhibitor were injected and again the resulting permeability calculated.

Step 3: Flooding with Deionized Water

After the second step 40 pore volumes of deionized water were injected in order to get the final permeability and the increase in pressure.

The results are summarized in table 3.

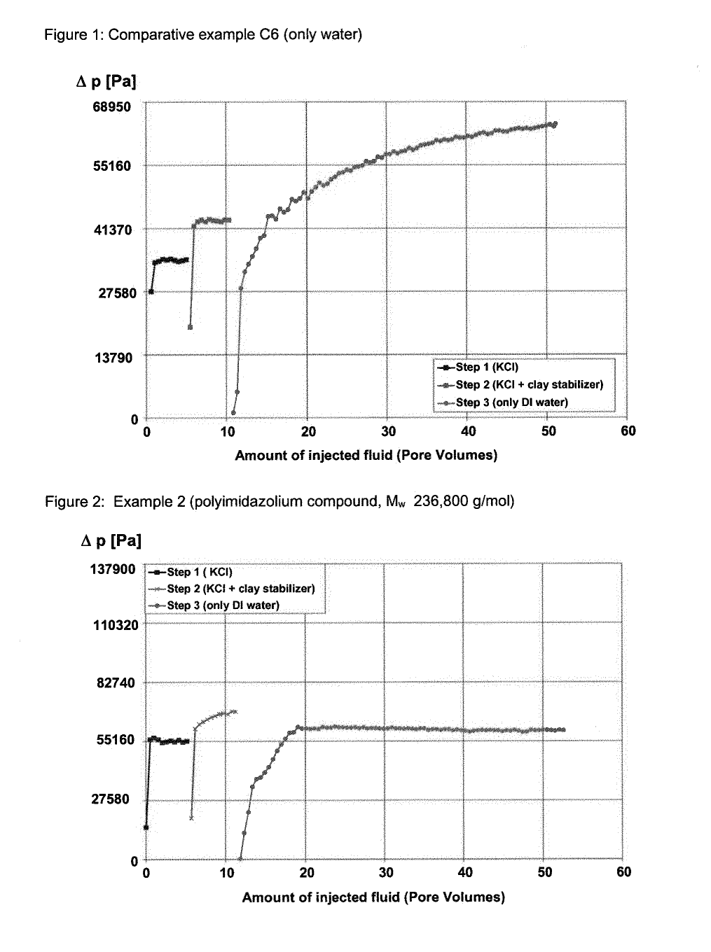

FIG. 1 shows the pressure difference as a function of the amount of Injected fluid (as pore volumes) for a test without clay stabilizer.

FIG. 2 shows the pressure as a function of the amount of injected fluid (as pore volumes) for sample 2 (polymeric imidazolium salt, M_{w} 236,800 g/mol).

TABLE 3
Results of the core flooding tests (*flow stopped before 40PV because of high pressure,
**Permeability after step 3/Permeability after step 1, 1,6-HMDA: 1,6-hexamethylene diamine)

| | Clay stabilizer | | | Core | | | |
|---|---|---|---|---|---|---|---|
| | | | concentration | Permeability after | | | Regain |
| No. | Sample | type | [% by wt.] | step 1 | step 2 | step 3 | Permeability** |
| Comparative Example C6 | — | — | — | 34 | — | 0.8* | 2% |
| Comparative Example C7 | 5 | monomeric imidazolium salt | 0.4 | 84 | 69 | 47 | 56% |
| Comparative Example C8 | 4 | Lysine based polyimidazolium compound, | 0.14 | 64 | 53 | 20 | 31% |
| | | M_{w} 6,330 g/mol | | | | | |
| Comparative Example C9 | 6 | Choline Chloride | 0.2 | 54 | 49 | 3 | 6% |
| Comparative Example C10 | 7 | Choline Formate | 0.2 | 85 | 83 | 2.9* | 3% |
| Comparative Example C11 | 8 | Commercial cationic copolymer | 0.1 | 75 | 66 | 64 | 85% |
| | | M_{w} 150,000 g/mol | | | | | |
| Comparative Example C12 | 1 | 1,6-HMDA based polyimidazolium | 0.19 | 67 | 66 | 54 | 81% |
| | | compound, M_{w} 69,000 g/mol | | | | | |
| Comparative Example C13 | 1 | 1,6-HMDA based polyimidazolium | 0.14 | 57 | 46 | 45 | 79% |
| | | compound, M_{w} 69,000 g/mol | | | | | |
| Example 2 | 2 | 1,6-HMDA based polyimidazolium | 0.024 | 59 | 47 | 51 | 86% |
| | | compound, M_{w} 236,800 g/mol | | | | | |
| Example 3 | 2 | 1,6-HMDA based polyimidazolium | 0.012 | 69 | 63 | 52 | 75% |
| | | compound, M_{w} 236,800 g/mol | | | | | |

### Comments:

FIG. 1 shows the pressure difference measured as a function of the amount of injected fluid (as pore volumes) for comparative example C7 (sample 5, monomeric imidazolium salt). The figure shows that a constant pressure was achieved after step 1 (injection of KCl, which is a clay stabilizer) indicating that KCl stabilized the clay. The injection of the clay stabilizer (step 2) also yielded a constant pressure while injecting it although the performance was not as good as that of KCl alone. However, injecting water in step 3 yields in a significant increase of the pressure, i.e. the stabilizing effect of the injected stabilizer disappeared the more water was injected. So, while sample 5 has a stabilizing effect it provides no long term stabilization.

FIG. 2 shows the technical performance of the polymeric clay stabilizers according to the present invention (example 2). Step 1 and step 2 are similar to the comparative example C7 shown in FIG. 1. However, during step 3 no increase of the pressure is observed but the pressure difference remains at a constant number. So, the polymers comprising imidazolium salts used according to the present invention have not only a stabilizing effect but the effect is also permanent.

Table 3 summarizes the results of all core flooding tests.

Comparative Example C6 is a test without any clay stabilizer used in step 2. The test was stopped before 40 pore volumes of deionized water passed through the core because the pressure became too high. Comparative example C11 with a commercial cationic polymer (an epiamine) was used as benchmark. At a concentration of 0.1% by weight regain of permeability after step 3 was 85%. The commercial polymer was compared with other commercially used stabilizers (choline chloride and choline formate). Both stabilizers showed no permanent stabilization (regain permeability only 6% resp. 3%).

Furthermore, the commercial polymer was compared with several imidazolium salts. A monomeric imidazolium salt (comparative example C7) showed even at a high concentration of 0.4% by weight only 56% regain permeability, i.e. its capability for permanent stabilization is poor. Also a very low M_{w} polyimidazolium compound (comparative example C8, M_{w} 6,330 g/mol) showed only a poor performance (regain permeability 31%). The polymeric polyimidazolium salts having an M_{w} of 69,000 g/mol (comparative examples C12 and C13) showed regain permeabilities comparable with those of the commercial polymer, however it was necessary to use more polymer to achieve the effect.

Example 2 with a polyimidazolium salt having an M_{w} of 236,800 g/mol showed an excellent performance: Regain permeability was even slightly larger than for the commercial polymer, however the effect was achieved with only 0.024% by wt., i.e. only a quarter of the amount of the commercial polymer! Reducing the amount of the polyimidazolium salt to 0.012% by weight slightly decreased the regain permeability value to 75%, however this still is a very good value.

1.-18. (canceled)

19. A method of inhibiting the swelling of clay in subterranean formations at least comprising introducing a carrier fluid comprising at least one clay inhibitor into the formation, wherein at least one of the clay inhibitors is a cationic polymer comprising repeating units (I) selected from the group of 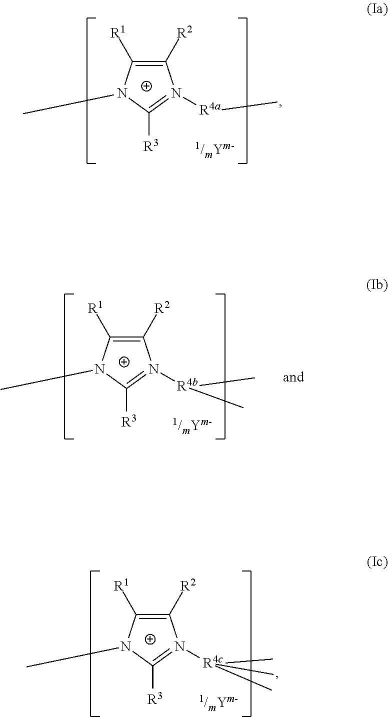
wherein
R¹, R², and R³ are each, independently of one another, H or a saturated or unsaturated, branched or unbranched, aliphatic and/or aromatic hydrocarbon moiety having from 1 to 20 carbon atoms which optionally may be substituted with functional groups,
R^{4a}, R^{4b}, R^{4c} are each, independently from one another, divalent, trivalent or tetravalent organic groups respectively comprising 2 to 50 carbon atoms, wherein the organic groups R^{4a}, R^{4b}, and R^{4c} may optionally comprise functional groups and/or non-neighboring carbon atoms may be substituted by heteroatoms,
Y^{m-} are each, independently of one another, anionic counter ions, wherein m is an integer from 1 to 4,
and wherein the cationic polymer has a weight average molecular weight M_{w} of at least 70,000 g/mol.

20. The method according to claim 19, wherein the weight average molecular weight M_{w} is from 70,000 g/mol to 1,000,000 g/mol.

21. The method according to claim 19, wherein the weight average molecular weight M_{w} is from 80,000 g/mol to 600,000 g/mol.

22. The method according to claim 19, wherein R^{4a}, R^{4b}, R^{4c} comprise 4 to 20 carbon atoms.

23. The method according to claim 19, wherein R^{4a}, R^{4b}, R^{4c} comprise at least one group selected from the group of ether groups, secondary amino groups or tertiary amino groups and apart from these no further functional groups.

24. The method according to claim 19, wherein R^{4a}, R^{4b}, R^{4c} are aliphatic groups.

25. The method according to claim 19, wherein R^{4a} is a C₂ to C₂₀ alkylene group.

26. The method according to claim 19, wherein R^{4a} is a C₄ to C₁₂ alkylene group.

27. The method according to claim 19, wherein the cationic polymer comprises repeating units (Ia).

28. The method according to claim 27, wherein the amount of repeating units (Ia) is at least 80 mol % relating to the total amount of all repeating units.

29. The method according to claim 19, wherein Y^{m-} is an anion of a mono- or polycarboxylic acid.

30. The method according to claim 29, wherein Y^{m-} is an acetate ion.

31. The method according to claim 19, wherein the cationic polymer is available by reacting at least an α-dicarbonyl compound, an aldehyde, at least one amino compound having 2 to 4 primary amino groups, and a protic acid with one another.

32. The method according to claim 19, wherein the concentration of the cationic polymers in the carrier fluid is from 0.001% to 1% by weight relating to the amount of all components of the carrier fluid.

33. The method according to claim 19, wherein the carrier fluid is an aqueous fluid.

34. The method according to claim 19, wherein the carrier fluid is selected from the group of drilling fluids, completion fluids, stimulation fluids, matrix acidizing fluids, production/remediation fluids, fluids for enhanced oil recovery (EOR), gravel packs, frac and pack fluids, and wellbore clean up fluids.

35. The method according to claim 19, wherein the carrier fluid is selected from the group of drilling fluids, completion fluids, fracturing fluids, matrix acidizing fluids, production/remediation fluids, fluids for enhanced oil recovery (EOR), gravel packs, frac and pack fluids, and wellbore clean up fluids.

36. The method according to claim 19, wherein the carrier fluid is acidic fracturing fluids, alkaline fracturing fluids or foamed fracturing fluids.

37. The method according to claim 19, wherein the carrier fluid is a pre-flush fluid and the treatment with the pre-flush fluid is followed by the treatment of the formation with a treatment fluid.

38. The method according to claim 19, wherein the carrier fluid is a hydraulic fracturing fluid comprising—besides the cationic polymer—at least a thickener and a proppant and the fluid is injected into the formation at a pressure sufficient to fracture the formation.
